(19) United States
(12) Patent Application Publication
(10) Pub. No.: US 2021/0164451 A1
(43) Pub. Date: Jun. 3, 2021

(54) INTERACTION METHOD AND APPARATUS

(71) Applicant: Paul Neiser, Mountain View, CA (US)

(72) Inventor: Paul Neiser, Mountain View, CA (US)

(21) Appl. No.: 16/772,875

(22) PCT Filed: Feb. 25, 2019
(86) PCT No.: PCT/US2019/019470

§ 371 Date: Jun. 15, 2020

Related U.S. Application Data
(60) Provisional application No. 62/710,607, filed on Feb. 23, 2018.

(51) Int. Cl. F03G 7/04

(52) U.S. Cl. CPC F03G 7/04

(57) ABSTRACT

Provided is an apparatus and method for interacting with the quantum vacuum. Example embodiments of the invention comprise a first reservoir which is configured to maintain a difference in the thermodynamic properties of the vacuum between the first reservoir and a second reservoir. The thermodynamic properties can refer to the pressure or the density of virtual particles within a specified reservoir. Example embodiments of the invention comprise a compression or expansion apparatus configured to generate and maintain a desired difference in the thermodynamic properties of the vacuum between a first reservoir and a second reservoir. Example embodiments employ the difference in the thermodynamic properties of the quantum vacuum within the first reservoir and baseline thermodynamic properties in a wide variety of applications.

This application claims the benefit of U.S. Provisional Application No. 62/710,607 filed on Feb. 23, 2018, which is incorporated herein by reference in its entirety.

### FIELD

The invention relates to apparatuses and methods for interacting with the quantum vacuum.

### BACKGROUND

Typical pumping apparatuses and methods are configured to pump a fluid such as a liquid or a gas. The pumping of fluid typically involves the drawing of fluid from a low pressure reservoir, the compression of a fluid by a pump or a compressor, and the expulsion of the fluid from the pump at a higher pressure. The fluid can be expulsed into a reservoir of the same pressure as the expulsed fluid in some applications. The fluid can also be expulsed into a reservoir of a pressure which is lower than the pressure of the expulsed fluid in some applications. The pump or the compressor typically does work on the fluid. Examples of such pumps are water pumps, such as the water pumps found on marine pump jet engines or the water pumps used at ground water wells, axial flow compressors in turbofan engines, the compressors found in refrigerators, bicycle pumps, or concrete pumps.

Typical turbine apparatuses and methods are configured to allow a fluid, such as a liquid or a gas, to do mechanical work. The extraction of work from a fluid typically involves the drawing of fluid from a high pressure reservoir, the expansion or the depressurization of a fluid in a turbine or an expander, and the expulsion of the fluid from the expander at a lower pressure. The fluid can be expulsed into a reservoir of the same pressure as the expulsed fluid in some applications. The fluid can also be expulsed into a reservoir of a pressure which is lower than the pressure of the expulsed fluid in some applications. Examples of such expanders are the axial flow turbine found on turbofan engines, a Francis turbine found in a hydroelectric power plant, or the piston in a steam locomotive.

Typical reservoirs are open reservoirs, such as the ocean, a lake, the atmosphere, or closed reservoirs, such as the refrigerating chamber in a refrigerator, or the pressure vessel of a natural gas tank.

### SUMMARY

Provided is an apparatus and method for interacting with the quantum vacuum. Example embodiments of the invention comprise a first reservoir which is configured to maintain a difference in the thermodynamic properties of the vacuum between the first reservoir and a second reservoir. The thermodynamic properties can refer to the pressure, temperature, or the density of virtual particles within a specified reservoir. Example embodiments of the invention comprise a compression or expansion apparatus configured to generate and maintain a desired difference in the thermodynamic properties of the vacuum between a first reservoir and a second reservoir. Example embodiments employ the difference in the thermodynamic properties of the quantum vacuum within the first reservoir and baseline thermodynamic properties in a wide variety of applications.

### BRIEF DESCRIPTION OF THE DRAWINGS

FIG. 1 is a cross-sectional view of one embodiment of the invention.

FIG. 2 is a cross-sectional view of another embodiment of the invention.

FIG. 3 shows the embodiment of FIG. 2 in a different configuration.

FIG. 4 is a cross-sectional view of another embodiment of the invention.

FIG. 5 is a cross-sectional view of another embodiment of the invention.

### DETAILED DESCRIPTION OF THE DRAWINGS

Provided is a method and apparatus for interacting with the quantum vacuum.

The term “medium” used herein describes any volume which is capable of containing, carrying, transporting, or transferring an object. By default, a medium refers to the collection of all objects which interact with a specified apparatus.

The term “object” used herein describes any component of a medium. The invention applies to any medium which can be considered to comprise at least one distinct object. An object may be conventionally referred to as a wave, such as a photon, or a particle, such as a proton. A medium may comprise several different types, species, or classes of objects.

One can consider the quantum vacuum to be a medium comprising virtual objects, where a virtual object denotes a fluctuation in the quantum vacuum which temporarily exhibits some or all of the properties of a corresponding conventional or real object. Examples of virtual objects are virtual photons, virtual electrons, virtual positrons, virtual quarks, or virtual gluons. For simplicity, the term “vacuum” is used to refer to the quantum vacuum described by quantum field theory. The term “virtual particle” is used to refer to a distinct component of the quantum vacuum, where the component can be a virtual particle such as a virtual electron, or considered to be a virtual wave, such as a virtual photon. The term virtual particle and virtual object are used interchangeably herein.

Example embodiments of the invention comprise a first reservoir which is configured to maintain a difference in the thermodynamic properties of the vacuum between the first reservoir and a second reservoir. For instance, the pressure, temperature, or density of virtual particles in the first reservoir can be larger or smaller than the pressure, temperature, or density of virtual particles in the second reservoir. The first reservoir is finite in size, and can be a chamber enclosed by insulating material, where the insulating material is configured with a transmissivity to virtual particles which is smaller than unity. The second reservoir can be the portion of the universe which excludes the first reservoir in some embodiments. In other embodiments, the second reservoir can be configured in similar manner as the first reservoir, i.e. the second reservoir can be a chamber enclosed by insulating material.

Example embodiments of the invention comprise a compression or expansion apparatus configured to generate and maintain a desired difference in the thermodynamic properties of the vacuum between a first reservoir and a second reservoir. For instance, for some embodiments of the invention, the compression apparatus can comprise a pumping apparatus, which is configured to increase the density of virtual particles in the first reservoir compared to the second reservoir. In another example, a pumping apparatus can be configured to reduce the density of virtual particles in the first reservoir compared to the second reservoir. For some embodiments, the expansion apparatus can comprise a turbine, which can be configured to allow the virtual particles in the quantum vacuum to do mechanical work. For instance, a difference in the pressure of virtual particles in the first reservoir and the second reservoir can be employed to generate a bulk flow of virtual particles through a suitably configured turbine, where the virtual particles are allowed to do mechanical work against the turbine before being expelled at a lower pressure to the low pressure reservoir.

Example embodiments of the invention can comprise other apparatuses such as valves, load chambers, doors, additional compressors or expanders, or additional reservoirs connected to the first reservoir by valves, gates, expanders, or turbines. For example, a load apparatus can be employed to transfer material into and out of the first reservoir. A load apparatus can comprise an insulated reservoir or load chamber, as well as a first insulated door to a source reservoir, where the source reservoir can be the second reservoir or a third reservoir, as well as a second insulated door to the first reservoir, as well as a pumping apparatus or a compression apparatus. The pumping or compression apparatus can be connected to the load chamber and the source reservoir. The compression apparatus can be configured to change the thermodynamic properties of the quantum vacuum within the load chamber in a manner in which the pressure of the quantum vacuum within the load chamber matches the pressure in the first reservoir. In some embodiments, the compression apparatus can be configured in a manner in which the pressure of the quantum vacuum within the load chamber matches the pressure in the source reservoir. In some embodiments, the load apparatus comprises a valve, which is configured in a manner in which the pressure of the quantum vacuum within the load chamber can be modified slowly by allowing virtual particles to enter or exit the load chamber from or into the source reservoir. In some embodiments, the load apparatus comprises a valve, which is configured in a manner in which the pressure of the quantum vacuum within the load chamber can be modified slowly by allowing virtual particles to enter or exit the load chamber from or into the first reservoir.

Consider a scenario in which both the first and second insulated doors are closed and the pressure of the quantum vacuum in the load chamber is equal to the pressure in the source reservoir. The first insulated door can be opened, and material can be inserted into the load chamber from the source reservoir. The first insulated door can be closed, and the pressure within the load chamber can be gradually changed to the value of the pressure of the quantum vacuum in the first reservoir. Once the pressure in the load chamber and the first reservoir are substantially equal, the second insulated door can be opened, and the material in the load chamber can be inserted into the first reservoir. Material can be transferred from the first reservoir into the source reservoir in a similar fashion. The load apparatus can therefore be configured and operated in a similar manner as conventional load locks, or conventional locks used in the transfer of ships between canals or reservoirs of varying water levels.

Continuously variable valves can be employed to regulate the flow rate of virtual particles through an insulated pipe, such as a pipe connecting a first and second reservoir, or a source reservoir and a first reservoir, or a load chamber and a source reservoir, or a load chamber and a first reservoir, or a first reservoir with a compression or expansion apparatus, or a second reservoir with a compression or expansion apparatus. A valve can be employed to change the cross-sectional area of an insulated pipe between a maximum cross-sectional area and a minimum cross-sectional area in continuously variable fashion. The minimum cross-sectional area can be zero, for example. A wide variety of valve architectures can be employed.

For example, an axially symmetric translating plug can be located concentrically within a circular pipe and moved parallel to a flow direction relative to a constriction in the cross-sectional diameter of a pipe, such that the position of the plug can be used to control the minimum cross-sectional area of the pipe. In other examples, other types of valves can be used, such as butterfly valves, ball valves, or gate valves.

Example embodiments employ the difference in the thermodynamic properties of the quantum vacuum within the first or second reservoir compared to baseline thermodynamic properties, where the “baseline properties” are the average thermodynamic properties of the quantum vacuum on the surface of earth, unless otherwise specified.

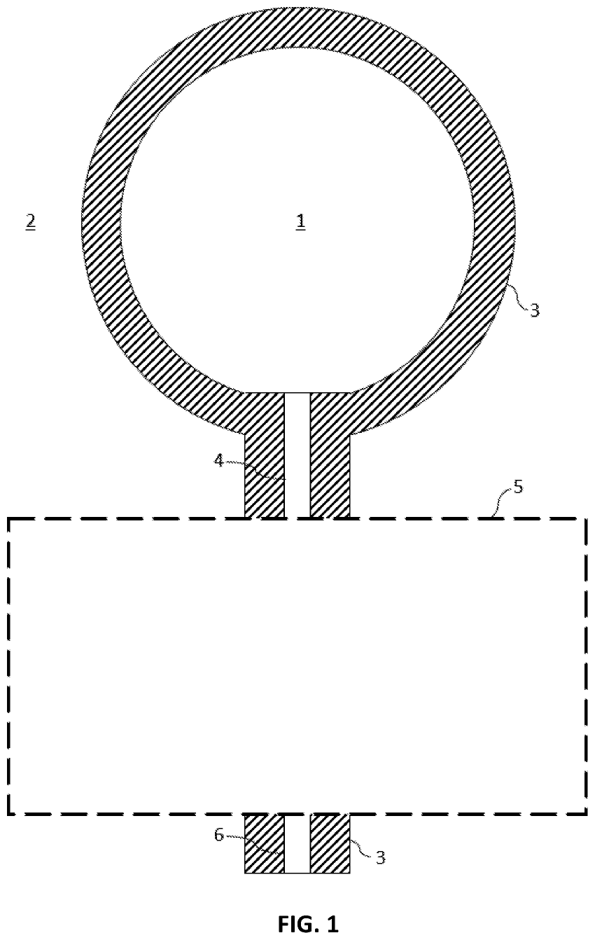

FIG. 1 is a cross-sectional view of one embodiment of the invention. There is a first reservoir 1 and a second reservoir 2. The reservoirs are separated by insulating material 3, which is configured to thermally, electrically, magnetically, and mechanically insulate the first reservoir 1 from the second reservoir 2. All surfaces of insulating material 3 are perfectly conductive in this embodiment. In other embodiments, this need not be the case. Insulating material 3 may comprise a superconducting material, a normally conducting material such as metal, a semiconductor such as silicon, or an insulator such as glass. In other embodiments, the surface of insulating material 3 may also be coated in a material with specially adapted properties. If the desired insulation requires a high electrical conductivity, coating materials such as copper, silver, or graphene may be used. Insulating material 3 can also be a metal such as aluminium or titanium. Insulating material 3 can also comprise composite materials such as carbon fiber or fiberglass. Insulating material 3 is neutrally charged in this simplified embodiment. Insulating material 3 forms a spherical boundary around the first reservoir 1 in this embodiment. In other embodiments, the boundary of the first reservoir 1 may be any shape, such as cylindrical with two hemispherical ends, elliptical, or rectangular. The interior surface of insulating material 3, i.e. the surface facing the first reservoir 1, may be maintained at or close to zero degrees Kelvin for some embodiments, such as embodiments in which the insulating material 3 is superconducting. In this simplified example, insulating material 3 may be considered to be perfectly reflective with respect to virtual or real objects in the medium in the first reservoir 1 and the second reservoir 2, and may be considered to have a zero emissivity of objects. In practice, and in a typical embodiment, the insulating material 3 is not perfectly reflective to all virtual objects. Insulating material 3 can have a transmissivity greater than zero for a portion of virtual objects, such as virtual photons of high frequency or short wavelength. Insulating material 3 is configured to have a transmissivity smaller than unity to at least a portion of virtual objects. The transmissivity can be 0.99 for a subset of virtual objects, for example. The transmissivity can be 0.2 for a subset of virtual objects in another example. The transmissivity can be 0.01 for a subset of virtual objects in another example. The medium in the first reservoir 1 and the second reservoir 2 is a vacuum in this embodiment. The second reservoir 2 can be considered to comprise the rest of the universe. Unless specified, the “apparatus” is defined to be the material enclosed by the exterior surface of the apparatus, i.e. the surface facing the second reservoir 2. Note that the surface of the exit channel 6 is not included in the aforementioned exterior surface.

A pumping apparatus 5 forms an interface between the first reservoir 1 and the second reservoir 2 via connecting channel 4 and exit channel 6. The pumping apparatus 5 is configured to regulate or modify the thermodynamic properties of the quantum vacuum, such as the zero-point energy, the density, the temperature, or the pressure of the quantum vacuum, in the first reservoir 1 relative to the second reservoir 2. The zero-point energy can be considered to be the energy associated with virtual objects. In this embodiment, the pumping apparatus 5 is configured to maintain the zero-point energy of the medium in the first reservoir 1 at a lower value relative to the zero-point energy of the medium in the second reservoir 2 surrounding the first reservoir 1. Note that in other embodiments the pumping apparatus 5 may also be configured in a manner in which the average zero-point energy in the first reservoir 1 is larger than the average zero-point energy in the second reservoir 2 surrounding the apparatus. The term “zero-point energy” as used herein refers to the thermodynamic properties of the quantum vacuum in general. A larger pressure of virtual particles is associated with a larger zero-point energy in the simplified examples discussed herein.

The pumping of virtual objects has several applications. For example, there may be a spatial or temporal gradient of the value of the pressure of virtual objects throughout the universe. For a given spatial gradient of the density or pressure of virtual objects in the second reservoir 2 surrounding the apparatus, and a given average value of the pressure of virtual objects within the first reservoir 1, a net force may arise on the apparatus. This force is similar in principle to a buoyancy force acting on a blimp or an airship suspended in the atmosphere by a gravity induced density gradient and the careful regulation of the average density of the airship. Embodiments of the invention may experience a net buoyancy force due to a gravity induced density gradient or pressure gradient of virtual particles in the second reservoir 2. For instance, the density and pressure of virtual objects can increase in a direction of gravitational acceleration on the surface of earth. This density gradient of virtual particles can be considered to generate a net force on the surface of the apparatus which faces the second reservoir 2. By regulating the average density of virtual objects within the apparatus, the average density, or the mass, of the apparatus may be controlled, where the average density is calculated over all objects, virtual or real, within the apparatus. During hovering or constant velocity flight, the average density may be regulated in a manner in which the magnitude of the buoyancy force is balanced by the gravitational force on the apparatus, for instance. Note that, in this manner, a lift force can be generated in the absence of an atmosphere. For example, a lift force can be generated in the vacuum of space. The lift force can be manipulated to exceed, balance, or only partially cancel the gravitational force, i.e. the weight force, on the apparatus. An apparatus can therefore be used to control the altitude of a spacecraft or a satellite relative to the surface of earth, for example.

The modification of the thermodynamic properties of the quantum vacuum within a reservoir can also be used to store energy in a manner similar to compressed air energy storage devices known in the art. In this case, the pumping apparatus may consist of, or may also comprise, mechanical elements such as a piston and valves or a turbine in order to convert the difference in the thermodynamic properties of the quantum vacuum into mechanical energy, for example.

A modification of the average thermodynamic properties of the quantum vacuum may also modify the coefficients of permeability and permittivity in the first reservoir 1 compared to the second reservoir 2. This may change the value of the refractive index in the first reservoir 1 compared to the second reservoir 2. For example, the first reservoir 1 may be shaped in the form of a double convex or concave lens, which may be used to defocus or focus real or virtual photons, or other wavelike objects, such as electrons.

The modification of the zero-point energy within the first reservoir 1 can therefore modify the speed of light in the quantum vacuum in first reservoir 1. This can modify the rate of the passage of time, as describe by general relativity. In other words, the modification of the thermodynamic properties of the quantum vacuum within the first reservoir 1 can modify the frequency of oscillation of atoms in an atomic clock in the first reservoir 1 compared to an identical atomic clock in the second reservoir 2. By increasing the density of virtual objects within the first reservoir 1 compared to the second reservoir 2, the rate of the passage of time can be reduced. This is similar in nature to the reduced rate of passage of time at a second point in a gravitational well compared to a first point in a gravitational well, where the second point is located deeper inside the gravitational well compared to the first point, as described by general relativity. By reducing the density of virtual objects within the first reservoir 1 compared to the second reservoir 2, the rate of the passage of time can be increased.

There are several applications of such a time modification device. By placing human beings within the first reservoir 1 for a certain period of time, the age of said human beings relative to human beings located in the second reservoir 2 within the same period of time can be modified. For example, the age of the human beings in the first reservoir can be reduced relative to the age of the human beings in the second reservoir in the case in which the rate of passage of time is reduced in the first reservoir compared to the second reservoir. This can be useful for applications in which the human beings in the first reservoir are afflicted with an incurable, terminal illness. The apparatus can be used as a life extension apparatus, which can be employed to increase the duration of time in which a cure can be found. Similarly, individuals working on important, time constrained projects can work on these projects within a first reservoir featuring a faster rate of passage of time compared to a second reservoir. Thus more work can be accomplished in the first reservoir within a given period of time in the second reservoir.

Similarly, the modification of the thermodynamic properties of the quantum vacuum can also affect the level of radioactivity of a material. By placing a radioactive material within a suitably configured first reservoir, the level of radioactivity can be reduced or increased. This can be used to reduce the half-life or increase the half-lift of the material relative to the material in the second reservoir.

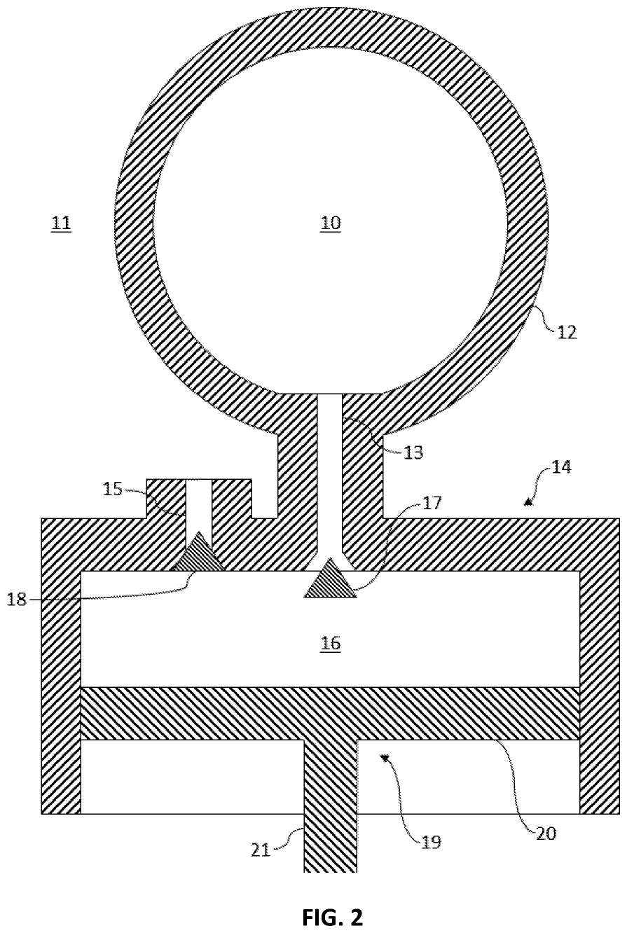

FIG. 2 is a cross-sectional view of another embodiment of the invention. The features and principles of operation discussed in the context of FIG. 1 are also relevant to the embodiment in FIG. 2.

In FIG. 2, the pumping apparatus 14 is connected to the first reservoir 10 by a connecting channel 13 and to the second reservoir 11 by an exit channel 15. Pumping apparatus 14 comprises a piston 19 with a piston shaft 21 and a piston head 20. The actuator for actuating the piston is not shown in FIG. 2. The material of piston 19 has similar insulating properties as insulating material 12. For instance, the surfaces of the piston 19 are assumed to be perfectly conducting, neutrally charged, and at or close to zero degrees Kelvin in this simplified example. Chamber 16 is therefore assumed to be perfectly insulated by insulating material 12 and piston 19. Piston 19 is configured to modify the volume of chamber 16 by moving along the Y-direction relative to insulating material 12. A first valve 17 allows chamber 16 to be connected to first reservoir 10 via connecting channel 13. A second valve 18 allows chamber 16 to be connected to second reservoir 11 via exit channel 15.

Pumping apparatus 14 is configured to modify, control, regulate, or maintain a desired net difference in zero-point energy between the first reservoir 10 and the second reservoir 11. For example, consider a scenario in which the objective is to reduce the zero-point energy in the first reservoir 10 relative to the second reservoir 11, where the zero-point energy of the two reservoirs is initially identical and uniform. Initially the piston is in a fully extended position, which corresponds to the volume of chamber 16 being zero. The piston 19 is subsequently withdrawn and the first valve 17 is opened, while the second valve 18 remains closed. The withdrawal of piston 19 results in the diffusion, dispersal, or distribution of zero-point energy in the first reservoir 10 within the combined area of the first reservoir 10 and chamber 16, which now has a non-zero volume. As a result, the zero-point energy in chamber 16 is now finite, and the zero-point energy in the first reservoir 10 has been reduced compared its initial value. During this withdrawal of the piston 19, the actuator moving the piston consumes work. Following the maximum retraction of the piston 19, the first valve 17 is closed. The zero-point energy of the first reservoir 10 has thus been reduced. The piston 19 is subsequently extended once more, increasing the zero-point energy in chamber 16 as the volume of chamber 16 is reduced. This increase can be considered to arise from work being done on the virtual objects located within chamber 16. During this extension, the actuator is configured to recover energy arising from the work done by the difference in pressure on the side of the piston head 20 facing the second reservoir 11 and the side of the piston head 20 facing chamber 16. This difference in pressure is the consequence of the larger value of the zero-point energy of the second reservoir 11 compared to the value of the zero-point energy in chamber 16. For example, in the context of virtual photons, the zero-point field in the proximity of a surface gives rise to a radiation pressure on said surface. Once the zero-point energy in chamber 16 has reached the value of the zero point energy of the second reservoir 11, the second valve 18 is opened, and the piston 19 is extended further to the initial, fully extended position, after which valve 18 is closed once more. This portion of the extension does not require work by, or provide energy to the actuator in a simplified, frictionless scenario. This cycle, and variations thereof, can be repeated until the zero-point energy in the first reservoir 10 or the second reservoir 11 has reached a desired value.

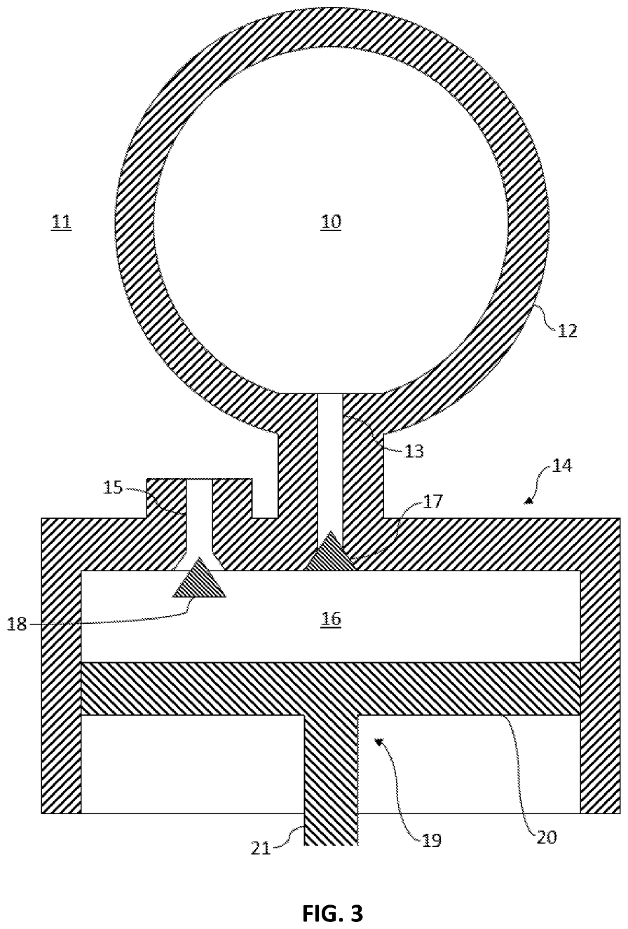

FIG. 3 is a cross-sectional view of the embodiment of the invention shown in FIG. 2, where the embodiment is in different configuration compared to the configuration in FIG. 2. FIG. 3 shows the piston 19 in a different location, and second valve 18 in an open as opposed to closed position, as well as first valve 17 in a closed as opposed to open position.

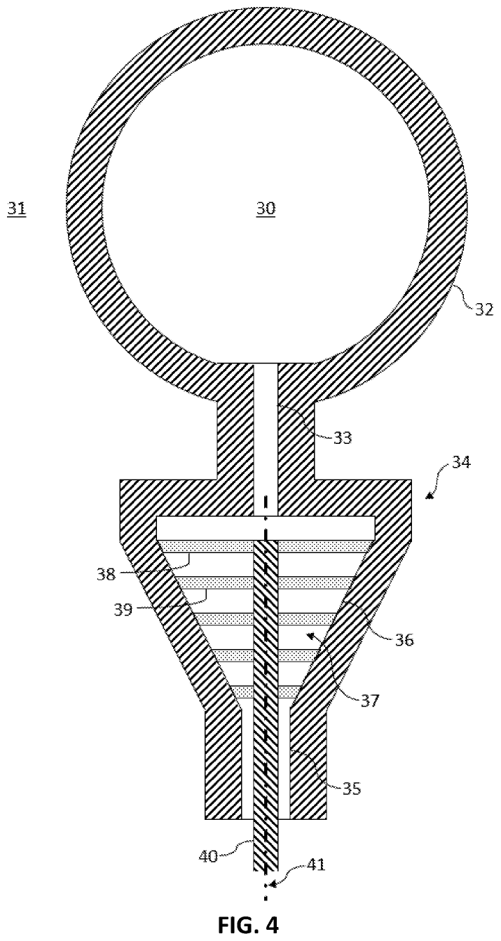

FIG. 4 is a cross-sectional view of another embodiment of the invention. The features and principles of operation discussed in the context of FIG. 1 are also relevant to the embodiment in FIG. 4.

In FIG. 4, the pumping apparatus 34 is connected to the first reservoir 30 by a connecting channel 33 and to the second reservoir 31 by an exit channel 35.

Pumping apparatus 34 comprises a compressor 37 with a shaft 40, and axis of rotation 41, and compressor rotor discs 38 or 39. In some embodiments, adjacent rotor discs, such as rotor disc 38 and rotor disc 39 are counter rotating. In some embodiments, compressor 37 can also comprise non-rotating stator discs located downstream of corresponding rotor discs, where a rotor disc and a corresponding stator disc form a compressor stage. The axis of rotation 41 is parallel to the Y-axis. An actuator for actuating the shaft 40 is provided, but not shown in FIG. 4. The material of the compressor blades and the compressor shaft 40 has similar insulating properties as insulating material 32. For instance, the surfaces of the compressor blades are assumed to be perfectly conducting, neutrally charged, and at or close to zero degrees Kelvin in this simplified example. In other embodiments, this need not be the case. For example, the temperature can be at 300 degrees Kelvin. For simplicity, chamber 36 is assumed to be perfectly insulated by insulating material 12 and compressor 37. The most suitable shape and geometry of the compressor 37 may be found using methods known in the art of compressor design. For clarity of illustration, the geometry of compressor 37 may be assumed to be similar to the geometry of conventional axial compressors. In other embodiments, compressor 37 can be configured in a similar manner as conventional centrifugal compressors.

In other embodiments 37, the compressor is configured to reduce the pressure and density of the quantum vacuum within the first reservoir 30 by pumping virtual objects from the first reservoir 30 into the second reservoir 31. In some such embodiments, a valve can be located within channel 33 and upstream of compressor 37, and configured to at least partially insulate first reservoir 30 from compressor 37 and second reservoir 31 when in a closed position. In an open position, the valve can allow the passage of virtual particles through channel 33. In other embodiments, the valve can be located downstream of compressor 37.

In some embodiments, the orientation of compressor 37 can be reversed. In other words, compressor 37 can be configured to increase the pressure or the density of virtual objects in first reservoir 30 relative to second reservoir 31. This can be accomplished by the pumping of virtual objects from the second reservoir 31 into the first reservoir 30.

Some embodiments can also comprise a second channel, configured in a similar manner as channel 33, and comprising at least one valve configured to at least partially insulate first reservoir 30 from second reservoir 31 when in a closed position. In an open position, the valve can allow the passage of virtual particles through the second channel. The valve can be configured to modify the minimum cross-sectional area of the second channel in continuous fashion between a maximum cross-sectional area at the valve and a minimum cross-sectional area at the valve. In this manner the flow rate of virtual objects through the second channel can be controlled by the valve.

The operation of an example embodiment can be described in the following example. The apparatus is configured in a similar manner as the apparatus shown in FIG. 4, with a first valve located in channel 33, and with a second channel, as previously described, comprising a second valve. Initially, the second valve is closed, and the first valve is open, while shaft 40 is not rotating. In this initial condition, the thermodynamic properties of the quantum vacuum in the first reservoir 30 and the second reservoir 31 are identical. An actuator, such as an electric motor, or a turboshaft jet engine, can be mechanically coupled to shaft 40, and can be employed to increase the rate of rotation of shaft 40 to a first rate of rotation. Due to the rotation of the rotor discs of compressor 37, virtual objects are pumped out of first reservoir 30 and into second reservoir 31, resulting in a reduction in the pressure and density of virtual objects in the first reservoir 30. In order to maintain a desired flow rate, the rate of rotation of shaft 40 can be increased as the vacuum pressure in the first reservoir 30 is reduced. Once a desired difference in the thermodynamic properties of the quantum vacuum between the first reservoir 30 and the second reservoir 31 has been reached, the first valve can be closed. In some embodiments, there can be a leakage of virtual objects through bulk material 32 into first reservoir 30, or through bulk material 32 into channel 33 or into the second channel, or through the first valve, or through the second valve. In such embodiments, the first valve can be opened after the pressure in the first reservoir 30 has deviated by a specified amount from the desired pressure, and compressor 37 can be configured to reduce the pressure of the quantum vacuum within the first reservoir 30 once more to a desired pressure and the first valve can be closed once more. In this manner, a desired average pressure and an acceptable variance in the pressure of the quantum vacuum can be maintained within the first reservoir 30, where the average pressure can be lower than the average pressure in the second reservoir 31.

At a later point in time the pressure in the first reservoir 30 can be returned to the pressure in the second reservoir 31. It can be desirable to return the thermodynamic properties of the quantum vacuum in the first reservoir 30 to the thermodynamic properties of the second reservoir 31 in a gradual fashion. This can be accomplished by opening the first valve and gradually reducing the rate of rotation of shaft 40 to zero, for example. Alternatively, this can be accomplished by reducing the rate of rotation of shaft 40 to zero, and gradually opening the first valve from a fully closed position to a fully open position, where the gradual opening maintains a desired flow rate of virtual objects through channel 33 by controlling the minimum cross-sectional area of channel 33. Alternatively this can be accomplished by gradually opening the second valve from a fully closed position to a fully open position, where the gradual opening maintains a desired flow rate of virtual objects through the second channel by controlling the minimum cross-sectional area of the second channel.

The principle of operation of the depicted compressor 37 shares similarities with the operation of aforementioned conventional axial compressors, with the exception that the compressor 37 is configured to interact with virtual objects. Other embodiments for dynamical pumping apparatuses, such as embodiments employing translational rather than rotational blade motion, are deemed to be within the scope of the invention. Note that such turbomachinery may be configured or operated as a compressor or a turbine. Such a pumping apparatus may be used to reduce the zero-point energy in a first reservoir 30 relative to a second reservoir 31, or vice versa. A single first reservoir 30 may be connected to a second reservoir 31 more than one type of pumping apparatus, where the type may refer to a turbine or compressor.

Note that components or apparatuses described in this paper can also be used in the context of other applications. For instance, the embodiments of pumping apparatuses described in this paper may also be used for other applications involving mechanical work being done or recovered.

In accordance with the type of embodiment of the invention described in FIG. 4, the dynamical Casimir effect is employed to produce, maintain, or regulate a difference in the zero-point energy between a first reservoir 30 and a second reservoir 31.

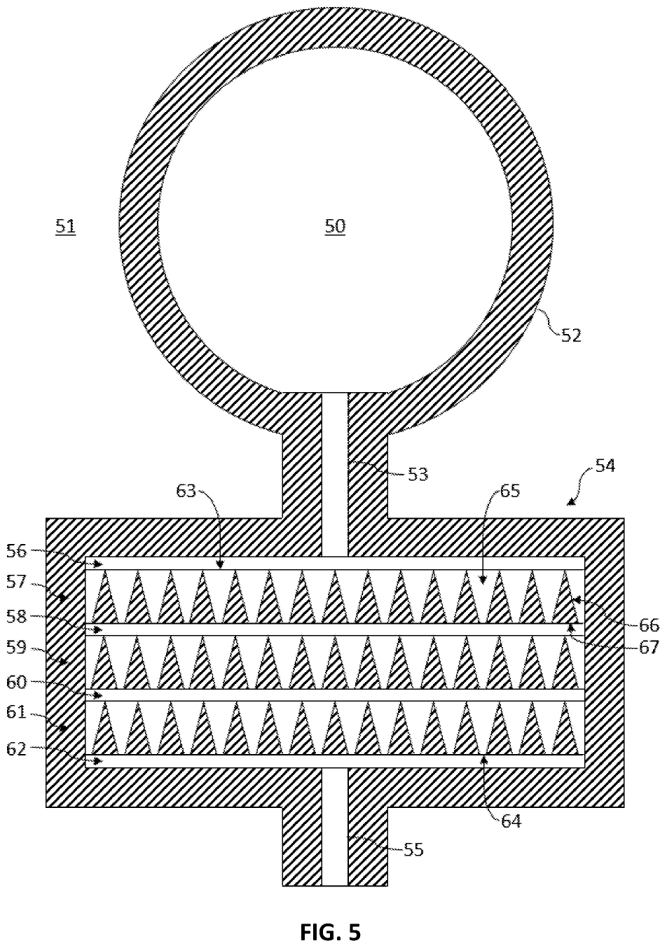

FIG. 5 is a cross-sectional view of another embodiment of the invention. The features and principles of operation discussed in the context of FIG. 1 are also relevant to the embodiment in FIG. 5.

In FIG. 5, the pumping apparatus 54 is connected to the first reservoir 50 by a connecting channel 53, and to the second reservoir 51 by an exit channel 55. Pumping apparatus 54 is configured to maintain a net difference in zero-point energy between the first reservoir 50 and the second reservoir 51. If the instantaneous difference is not equal to the reference or equilibrium difference, there will be a net diffusion of zero-point energy between the reservoirs. This is accomplished by a cascade of the three diffusion apparatuses 57, 59, and 61. The first station 56 of the first diffusion apparatus 57 is equivalent to the first reservoir 50. The second station 58 of the first diffusion apparatus 57 is equivalent to the first station of the second diffusion apparatus 59. The second station 60 of the second diffusion apparatus 59 is equivalent to the first station of the third diffusion apparatus 61. The second station of the third diffusion apparatus 61 is equivalent to the second reservoir 51.

Each diffusion apparatus comprises a first opening, such as first opening 63, which is connected via a channel, such as channel 65, to a second opening, such as second opening 64. There is a first surface, such as first surface 66, and a second surface, such as surface 67 associated with a diffusion apparatus. In this embodiment, a channel has a circular cross-section throughout when viewed along the Y-axis. The diameter of the first opening is larger than the diameter of the second opening. The geometric shape of the channel is provided by bulk material, which in this case is identical to insulating material 52. The bulk material is perfectly conducting in this embodiment. In other embodiments this need not be the case.

The geometry of a channel is configured to increase the zero-point energy in the proximity of the channel and thus in the proximity of the first surface compared to the zero-point energy in the proximity of the second surface. This forms a boundary condition for the zero-point energy of a finite reservoir located on the side of the first surface of the diffusion apparatus. Thus a diffusion apparatus can be configured to contribute to, or maintain, a difference in zero-point energy between at least one finite reservoir and another reservoir located at the first station or the second station of the diffusion apparatus. Using methods known in the art, an appropriate geometry and size or scale of a diffusion apparatus can be found for a given application.

In the steady-state, i.e. in an equilibrium configuration, there is no longer any diffusion of zero-point energy between the first reservoir 50 and the second reservoir 51, and the zero-point energy in the first reservoir 50 is larger than the zero-point energy in the second reservoir 51. The value of the zero-point energy in the first reservoir 50 in this equilibrium configuration is determined by the value of the zero-point energy at the interface between the exit channel 55 and the second reservoir 51, and the configuration of the pumping apparatus. If this equilibrium is disturbed, e.g. by an increase in the zero-point energy in the second reservoir 51, there will be a net diffusion of zero-point energy from the second reservoir 51 through the pumping apparatus 54 to the first reservoir 50. Since the second reservoir 51 is much larger than the first reservoir 50 in this example, the value of the zero-point energy in the second reservoir 51 can be considered to control, or form a boundary condition for, the zero-point energy in the first reservoir 50.

In some embodiments, several different types of pumps can be employed in the modification of the thermodynamic properties of the quantum vacuum of a single first reservoir. For example, a channel, such as channel 33, can comprise a first compressor, of the same type as compressor 37 in FIG. 4, a second compressor, of the same type as compressor 54 shown in FIG. 5, where the channel connects the first and second compressor in series. Both the first and second compressor can be configured to reduce the pressure or density of virtual objects in the first reservoir relative to the second reservoir, for example. In another example, the first and second compressor can be configured to increase the pressure or density of virtual objects in the first reservoir relative to the second reservoir. The first and second compressors can be configured to complement each other. For example, the second compressor can be mounted between the first compressor and the first reservoir. The second compressor can be considered to be a low pressure compressor, configured to increase the low pressure of virtual objects exiting the first reservoir to a value above the pressure of virtual objects in the first reservoir. The first compressor can be considered to be a high pressure compressor, configured to increase the pressure of virtual objects exiting the second compressor to a value substantially equal to the pressure of virtual objects in the second reservoir. The latter allows the expulsion of virtual objects from the exit of the first compressor into the second reservoir.

In another example a first and second compressor can be mounted in parallel. In other words, an apparatus can include a first channel comprising a first compressor and a first valve, as well as a second channel comprising a second compressor and a second valve. During a process which modifies the thermodynamic properties of the quantum vacuum in the first reservoir relative to the second reservoir, the second valve can be closed and the first valve can be open while the first compressor is configured to increase or reduce the pressure or density of virtual objects in the first reservoir relative to the second reservoir. At a given pressure or density difference between the first and second reservoir, the first valve can be closed, and the second valve can be opened while the second compressor is configured to further increase or reduce the pressure or density of virtual objects in the first reservoir relative to the second reservoir. Once a specified difference in the thermodynamic properties between the first and second reservoir has been reached, the second valve can be closed.

In some embodiments, such as embodiments in which virtual particles are able to diffuse or leak through the insulating bulk material surrounding a first reservoir, an adjacent channel, or an adjacent valve, a compressor or pumping apparatus can be pumping virtual objects out of the first reservoir at a rate which matches the rate of leakage of virtual objects into the first reservoir for a scenario in which the pressure of virtual objects in the first reservoir is desired to be constant in time. In the scenario in which the pressure of virtual objects in the first reservoir is larger than in the second reservoir, the direction of the pumping is reversed, i.e. at least one compressor can be configured to pump virtual objects into of the first reservoir at a rate which matches the rate of leakage of virtual objects out of the first reservoir for a scenario in which the pressure of virtual objects in the first reservoir is desired to be constant in time.

The first compressor can be employed to modify the thermodynamic properties of the quantum vacuum in the first reservoir by a specified amount.

Unless specified or clear from context, the term “or” is equivalent to “and/or” throughout this paper.

The embodiments and methods described in this paper are only meant to exemplify and illustrate the principles of the invention. This invention can be carried out in several different ways and is not limited to the examples, embodiments, arrangements, configurations, or methods of operation described in this paper or depicted in the drawings. This also applies to cases where just one embodiment is described or depicted. Those skilled in the art will be able to devise numerous alternative examples, embodiments, arrangements, configurations, or methods of operation, that, while not shown or described herein, embody the principles of the invention and thus are within its spirit and scope.

### ASPECTS OF THE INVENTION

The invention is further defined by the following aspects.

Aspect 1. An apparatus for modifying the thermodynamic properties of the quantum vacuum, wherein the apparatus comprises: a first reservoir enclosed by an insulating bulk material; a pumping apparatus, wherein the pumping apparatus is located between a first opening to a first reservoir and a second opening to a second reservoir, and wherein the pumping apparatus is configured to modify the thermodynamic properties of the quantum vacuum in the first reservoir relative to the second reservoir by interacting with the quantum vacuum.

Aspect 2. The apparatus of aspect 1, wherein the interaction with the quantum vacuum comprises the compression of the quantum vacuum

Aspect 3. The apparatus of aspect 1, wherein the interaction with the quantum vacuum comprises a net diffusion or a bulk flow of the quantum vacuum from the first reservoir to the second reservoir, or from the second reservoir to the first reservoir

Aspect 4. The apparatus of aspect 1, wherein the apparatus comprises a channel enclosed by insulating bulk material and extending from a first opening at the first reservoir to the second opening at the second reservoir, and wherein the insulating material of the channel encloses the pumping apparatus.

Aspect 5. The apparatus of aspect 1, wherein the channel comprises at least one valve configured to insulate the first reservoir from the second reservoir when in a closed position, and to allow the flow of the quantum vacuum through the channel when in an open position.

Aspect 6. The apparatus of aspect 5, wherein the valve is configured to control the flow rate of the quantum vacuum through the channel.

Aspect 7. The apparatus of aspect 1, wherein the thermodynamic properties refer to the pressure, temperature, or density of the quantum vacuum.

Aspect 8. The apparatus of aspect 1, wherein the transmissivity of the insulating bulk material to at least a portion of virtual objects in the quantum vacuum is less than one.

Aspect 9. The apparatus of aspect 1, wherein the pumping apparatus is of a reciprocating piston type.

Aspect 10. The apparatus of aspect 1, wherein the pumping apparatus is of an axial or centrifugal compressor type

Aspect 11. The apparatus of aspect 1, wherein the pumping apparatus is of a diffusion type.

Aspect 12. The apparatus of aspect 1, wherein the interior of the first reservoir is spherical in shape.

Aspect 13. The apparatus of aspect 1, wherein the interior of the first reservoir is cylindrical in shape, wherein the ends of the cylinder are hemispherical in shape.

Aspect 14. The apparatus of aspect 1, wherein the interior of the first reservoir is elliptical in shape.

Aspect 15. The apparatus of aspect 1, further comprising a valve configured to at least partially insulate the first reservoir from the second reservoir when in a closed position, and to allow virtual objects to flow or diffuse from the first reservoir to the second reservoir, or from the second reservoir to the first reservoir, when in an open position.

Aspect 16. The apparatus of aspect 15, wherein the valve is located between a first opening to the first reservoir and a second opening to the second reservoir

Aspect 17. The apparatus of aspect 15, wherein the valve is configured to control the flow rate of virtual objects between the first reservoir and the second reservoir

Aspect 18. The apparatus of aspect 1, further comprising a load lock configured to facilitate the transfer of material from the first reservoir to the second reservoir, and from the second reservoir to the first reservoir without substantially modifying the thermodynamic properties of the quantum vacuum within the first reservoir.

Aspect 19. A method modifying the thermodynamic properties of the quantum vacuum within a first reservoir relative to a second reservoir, comprising, providing any apparatus of aspects 1 to 18, activating the pumping apparatus to thereby modify the thermodynamic properties of the quantum vacuum within the first reservoir relative to the second reservoir, wherein the activating of the pumping apparatus can comprise the opening of a valve, the charging of collections of charge within the pumping apparatus, the application of a voltage to elements of the pumping apparatus, or the delivery of power to an actuator, or the rotation of a drive shaft, for example.

Aspect 20. A method of aspect 19, further comprising modifying the properties of a material relative to the properties of said material in a second reservoir by transferring the material from the second reservoir into the first reservoir, and exposing the material in the first reservoir to a quantum vacuum with different thermodynamic properties than the quantum vacuum in the second reservoir.

Aspect 21. A method of aspect 20, further comprising transferring the material from the first reservoir back to the second reservoir after a specified amount of time in the first reservoir.

Aspect 22. A method of aspect 20 or aspect 21, wherein the transfer of material is facilitated by the load lock.

Aspect 23. A method of aspect 20 or aspect 21, wherein the transfer of material comprises equilibrating the pressure of the quantum vacuum in the first and second reservoirs, transferring the material through a channel with opened valves or insulated doors, closing said valves or insulated doors, and modifying the pressure of the quantum vacuum in the first reservoir relative to the second reservoir by activating a pumping apparatus.

Aspect 24. A method of aspect 20 or aspect 21, wherein the material comprises a human being.

Aspect 25. A method of aspect 20, or aspect 21 or aspect 24, wherein the properties of a material comprise to the age of the material

Aspect 26. A method of aspect 20, or aspect 21, wherein the material comprises life support equipment such as water, food, medical devices or instruments, robotic systems, information, or materials related to sanitation.

Aspect 27. A method of aspect 20, or aspect 21, wherein the material comprises a conductor.

Aspect 28. A method of aspect 20, or aspect 21 or aspect 27, wherein the properties of the material comprise the conductivity of the material.

Aspect 29. A method of aspect 20, or aspect 21, wherein the material comprises radioactive material.

Aspect 30. A method of aspect 20, or aspect 21 or aspect 29, wherein the properties of a material refer to the level of radioactivity of a material.

Aspect 31. A method of aspect 20, wherein the properties of a material refer to the acceleration due to gravity of said material.

Aspect 32. The apparatus of aspect 1, wherein the interior of the first reservoir is in the shape of a converging or diverging lens, and wherein the refractive index of the quantum vacuum within the first reservoir is different to the refractive index in the second reservoir.

Aspect 33. A method of refracting virtual or real objects, such as virtual or real photons, or virtual or real electrons, comprising providing any apparatuses of aspects 1 to 18, the method of aspect 19, and the apparatus of aspect 32, and allowing said objects from the second reservoir to pass through the insulating bulk material of the first reservoir and into the first reservoir.

Aspect 34. A method of generating lift, the method comprising providing any apparatuses of aspects 1 to 18, the method of aspect 19, and employing a pressure gradient in the quantum vacuum in a second reservoir in order to generate a net lift force acting on the insulating bulk material containing a first reservoir.

Aspect 35. A method of aspect 34, where the net force is a buoyancy force.

Aspect 36. A method of aspect 34, where the pressure of the quantum vacuum within the first reservoir is smaller on average than the average pressure of the quantum vacuum acting on the apparatus from the second reservoir.

Aspect 37. A method of aspect 34, where the density of the quantum vacuum within the first reservoir is smaller on average than the average density of the quantum vacuum in the second reservoir in the vicinity of the bulk material of the first reservoir.

Aspect 38. A method of aspect 34, where the net lift force is directed in the opposite direction of a gravitational acceleration.

1. An apparatus for modifying thermodynamic properties of a quantum vacuum, the apparatus comprising:
a first reservoir enclosed by an insulating bulk material, the first reservoir having a first opening;
a pumping apparatus wherein the pumping apparatus is located between the first opening of the first reservoir and a second opening of a second reservoir, and the pumping apparatus being configured to modify thermodynamic properties of a quantum vacuum in the first reservoir relative to the second reservoir by interacting with the quantum vacuum.

2. The apparatus of claim 1, wherein the interacting with the quantum vacuum comprises compression of the quantum vacuum.

3. The apparatus of claim 1, wherein the interacting with the quantum vacuum comprises a net diffusion or a bulk flow of the quantum vacuum.

4. The apparatus of claim 1, further comprising a channel enclosed by the insulating bulk material and extending from the first opening of the first reservoir to the second opening of the second reservoir, the insulating bulk material enclosing the pumping apparatus.

5. The apparatus of claim 4, wherein the channel comprises at least one valve configured to insulate the first reservoir from the second reservoir when in a closed position, and to allow flow of the quantum vacuum through the channel when in an open position.

6. The apparatus of claim 5, wherein the valve is configured to control a flow rate of the quantum vacuum through the channel.

7. The apparatus of claim 1, wherein the thermodynamic properties include one or more of pressure, temperature, or density of the quantum vacuum.

8. The apparatus of claim 1, wherein transmissivity of the insulating bulk material to at least a portion of virtual objects in the quantum vacuum is less than one.

9. The apparatus of claim 1, wherein the pumping apparatus is of a reciprocating piston type.

10. The apparatus of claim 1, wherein the pumping apparatus is of an axial or centrifugal compressor type.

11. The apparatus of claim 1, wherein the pumping apparatus is of a diffusion type.

12. The apparatus of claim 1, wherein an interior of the first reservoir is spherical in shape.

13. The apparatus of claim 1, wherein an interior of the first reservoir is cylindrical in shape with hemispherical ends.

14. The apparatus of claim 1, wherein an interior of the first reservoir is elliptical in shape.

15. The apparatus of claim 1, further comprising a valve configured to at least partially insulate the first reservoir from the second reservoir when in a closed position, and to allow virtual objects to flow or diffuse from the first reservoir to the second reservoir or from the second reservoir to the first reservoir when in an open position.

16. The apparatus of claim 15, wherein the valve is located between the first opening of the first reservoir and the second opening of the second reservoir

17. The apparatus of claim 15, wherein the valve is configured to control a flow rate of virtual objects between the first reservoir and the second reservoir.

18. The apparatus of claim 1, further comprising a load lock configured to facilitate transfer of material from the first reservoir to the second reservoir and from the second reservoir to the first reservoir without substantially modifying the thermodynamic properties of the quantum vacuum within the first reservoir.

19. A method modifying thermodynamic properties of a quantum vacuum within a first reservoir relative to a second reservoir, comprising:
providing a first reservoir enclosed by an insulating bulk material, the first reservoir having a first opening;
providing a pumping apparatus located between the first opening of the first reservoir and a second opening of a second reservoir, the pumping apparatus being configured to modify thermodynamic properties of a quantum vacuum in the first reservoir relative to the second reservoir by interacting with the quantum vacuum;
activating the pumping apparatus, to thereby modify the thermodynamic properties of the quantum vacuum within the first reservoir relative to the second reservoir.
